(19) United States
(12) Patent Application Publication
(10) Pub. No.: US 2026/0359590 A1
(43) Pub. Date: Nov. 12, 2026

(54) COMMUNICATION COMMAND PROCESSING METHOD AND CIRCUIT, CHIP, AND ELECTRONIC DEVICE

(71) Applicant: Guangzhou Zhono Microelectronics Co., Ltd, Guangzhou (CN)

(72) Inventor: Qin LI, Guangzhou (CN)

(21) Appl. No.: 19/408,415

(22) Filed: Dec. 4, 2025

(30) Foreign Application Priority Data
May 9, 2025 (CN) 202510597379.7

(51) Int. Cl. G06K 15/00

(52) U.S. Cl. CPC G06K 15/407

(57) ABSTRACT

Disclosed in this disclosure is a communication command processing method, including: acquiring a to-be-processed command, comparing the to-be-processed command with a stored historical command, and updating the historical command; if there is a same historical command, generating a first calculation result based on a first preset algorithm and a historical calculation result, and feeding back the first calculation result; and if the historical command is different from the to-be-processed command, generating a second calculation result based on a second preset algorithm, and feeding back the second calculation result to a target terminal device. This solution improves the authentication security and reduces the risk.

### CROSS-REFERENCE TO RELATED APPLICATIONS

The application claims priority to Chinese patent application No. 202510597379.7, filed on May 9, 2025, the entire contents of which are incorporated herein by reference.

### Technical Field

Embodiments of this disclosure relate to the technical field of integrated circuits, and in particular, to a communication command processing method and circuit, a chip, and an electronic device.

### Background

With the rapid development of electronic technology, integrated circuits are being widely used in various fields such as industry, communications, automobiles, the Internet of Things, and artificial intelligence. The importance of integrated circuit security is becoming increasingly prominent for the purpose of protecting the product ecosystem and user privacy security. For example, in specific scenarios such as consumer electronics accessories and printer toner cartridges, the terminal devices serving as the hosts often need to perform communication authentication on the accessories or third-party devices serving as the slaves. Only accessories or third-party devices that pass the authentication can be used normally.

The authentication method used in the related technologies is that the host sends a communication command to the slave, the slave receives the communication command, processes it, and feeds back the processing result, and the host then judges whether the authentication has passed based on the processing result. However, in the foregoing method, the slave outputs a single processing result for the same communication command, which has a high security risk, is easily attacked and decoded for imitation, and needs to be improved.

### SUMMARY

Embodiments of this disclosure provide a communication command processing method and circuit, a chip, and an electronic device, which solve the problems that the related technology has a high security risk, is easily attacked and decoded for imitation, and needs to be improved, and feed back different processing results generated based on a to-be-processed command itself or a historical calculation result for the same communication command, so that the flexibility of authentication calculation is improved, thereby increasing the imitation difficulty of the chip, improving the security of the authentication process, and reducing the security risk.

According to a first aspect, an embodiment of this disclosure provides a communication command processing method, including:
acquiring a to-be-processed command, comparing the to-be-processed command with at least one stored historical command to obtain a comparison result, and updating the at least one stored historical command based on the to-be-processed command;
under a condition that the comparison result is that there is a historical command the same as the to-be-processed command in the at least one historical command, generating a first calculation result based on a first preset algorithm and a stored historical calculation result corresponding to the to-be-processed command, updating the stored historical calculation result based on the first calculation result, and feeding back the first calculation result to a target terminal device; and
under a condition that the comparison result is that the historical command is different from the to-be-processed command, generating a second calculation result based on a second preset algorithm and the to-be-processed command, updating the stored historical calculation result based on the second calculation result, and feeding back the second calculation result to the target terminal device.

According to a second aspect, an embodiment of this disclosure further provides a communication command processing circuit, including:
a command comparison module, configured to receive a to-be-processed command, and configured to output a comparison result obtained by comparing the to-be-processed command with at least one stored historical command to a status control module;
the status control module, configured to output a first control signal to a first calculation module under a condition that the comparison result is that there is a historical command the same as the to-be-processed command in the at least one historical command, configured to output a second control signal to a second calculation module under a condition that the comparison result is that the historical command is different from the to-be-processed command, configured to control the command comparison module to update the at least one stored historical command based on the to-be-processed command, and configured to output a result selection signal to a selector module according to the comparison result
the first calculation module, configured to output a first calculation result generated based on a first preset algorithm and a stored historical calculation result corresponding to the to-be-processed command to the selector module under a condition that the first control signal is received;
the second calculation module, configured to receive the to-be-processed command, and configured to output a second calculation result generated based on a second preset algorithm and the to-be-processed command to the selector module and the first calculation module under a condition that the second control signal is received;
the status control module, further configured to control the first calculation module to update the stored historical calculation result based on the first calculation result or the second calculation result; and
the selector module, configured to output a target calculation result determined from the first calculation result and the second calculation result according to the result selection signal to a target terminal device.

According to a third aspect, an embodiment of this disclosure further provides a chip, including the communication command processing circuit according to any one of the embodiments in this disclosure.

According to a fourth aspect, an embodiment of this disclosure further provides an electronic device, including the chip according to any one of the embodiments in this disclosure.

As described above, embodiments of this disclosure provide a communication command processing method and circuit, a chip, and an electronic device. The communication command processing method includes: acquiring a to-be-processed command, comparing the to-be-processed command with at least one stored historical command to obtain a comparison result, and updating the at least one stored historical command based on the to-be-processed command; under a condition that the comparison result is that there is a historical command the same as the to-be-processed command in the at least one historical command, generating a first calculation result based on a first preset algorithm and a stored historical calculation result corresponding to the to-be-processed command, updating the stored historical calculation result based on the first calculation result, and feeding back the first calculation result to a target terminal device; and under a condition that the comparison result is that the historical command is different from the to-be-processed command, generating a second calculation result based on a second preset algorithm and the to-be-processed command, updating the stored historical calculation result based on the second calculation result, and feeding back the second calculation result to the target terminal device. The communication command processing circuit that implements the communication command processing method is provided with a command comparison module, a status control module, a first calculation module, a second calculation module, and a selector module. This solution feeds back different processing results generated based on the to-be-processed command itself or the historical calculation result for the same communication command, so that the flexibility of authentication calculation is improved, thereby increasing the imitation difficulty of the chip, improving the security of the authentication process, and reducing the security risk.

### BRIEF DESCRIPTION OF THE DRAWINGS

FIG. 1 is a flowchart of a communication command processing method according to an embodiment of this disclosure;

FIG. 2 is a schematic structural diagram of a communication command processing circuit according to an embodiment of this disclosure;

FIG. 3 is a schematic structural diagram of another communication command processing circuit according to an embodiment of this disclosure;

FIG. 4 is a schematic structural diagram of another communication command processing circuit according to an embodiment of this disclosure;

FIG. 5 is a schematic structural diagram of another communication command processing circuit according to an embodiment of this disclosure; and

FIG. 6 is a schematic structural diagram of another communication command processing circuit according to an embodiment of this disclosure.

### DETAILED DESCRIPTION OF THE EMBODIMENTS

The embodiments of this disclosure are further described in detail below in combination with the accompanying drawings and embodiments. It should be understood that the specific embodiments described herein are merely for explaining the embodiments of this disclosure rather than limiting the embodiments of this disclosure. It should also be noted that for ease of description, only the parts related to the embodiments of this disclosure are shown in the accompanying drawings rather than all the structures.

The terms “first”, “second”, and the like in the specification and claims of this disclosure are intended to distinguish between similar objects but not to indicate a specific order or sequence. It should be understood that the data used in this way is interchangeable in appropriate conditions, so that the embodiments of this disclosure can be implemented in an order other than those illustrated or described herein. Moreover, the objects distinguished by “first”, “second”, and the like are usually of one type, and the number of the objects is not limited. For example, a first object may be one or more and may also not be understood as indicating or implying relative importance. In addition, “and/or” in the specification and claims indicates at least one of the connected objects, and the character “/” generally indicates an “or” relationship between the preceding and following associated objects. In addition, unless otherwise explicitly specified and limited, the terms “dispose”, “mount”, “interconnect”, “connect”, and “connect in series” should be understood in a broad sense. For example, it may be a fixed connection, a detachable connection, or an integral connection; it may be a mechanical connection or an electrical connection; and it may be a direct interconnection, an indirect interconnection through an intermediate medium, or a communication within two elements. For those of ordinary skill in the art, the specific meanings of the above terms in this disclosure may be understood based on specific conditions.

In the related technology, a host may be a terminal device, and a slave may be an accessory chip or a third-party device. The host and the slave may perform mutual authentication or one-way authentication. The host and the slave perform data interaction through wired or wireless communication protocols and may determine whether the other party is trustworthy. In an example of authentication of a printer and a consumable chip, IIC (Inter-Integrated Circuit), SPI (Serial Peripheral Interface), and other communication protocols may be adopted. A specific host-to-slave authentication process is as follows: the host sends a command to the slave, and the command may include a command header representing an authentication function and input data used for calculation of an authentication algorithm; after receiving the command, the slave may identify the command header and determine it as an authentication command, transmit the received input data to an algorithm circuit, to obtain an algorithm result, and feed back the algorithm result to the host; and the host compares the received algorithm result with an expected value, and if the algorithm result and the expected value are consistent, the authentication is successful. However, the inventor has found that for the same authentication command provided by the host, the slave needs to take the same time to obtain the same algorithm result. The algorithm result is single and is easy to simulate and even imitate, and the security is low. Based on this, embodiments of this disclosure provide a communication command processing method and circuit, a chip, and an electronic device, aiming to solve the problems that the related technology has a high security risk, is easily attacked and decoded for imitation, and needs to be improved.

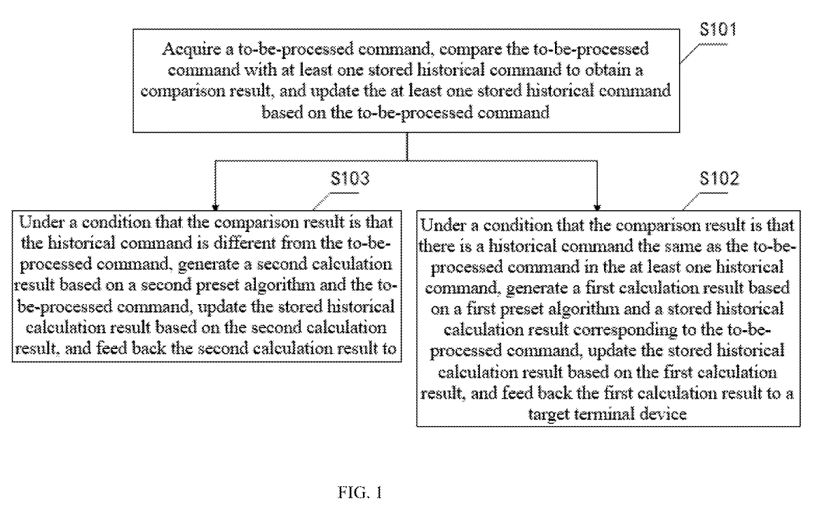

FIG. 1 is a flowchart of a communication command processing method according to an embodiment of this disclosure. As shown in FIG. 1, the communication command processing method may be applied to a slave in an authentication process, which specifically includes the following steps:

Step S101: acquiring a to-be-processed command, comparing the to-be-processed command with at least one stored historical command to obtain a comparison result, and updating the at least one stored historical command based on the to-be-processed command.

The to-be-processed command may be an authentication command sent by a host to a slave, which may include a command header and input data used for calculation of a preset algorithm. By comparing the to-be-processed command with the at least one stored historical command, whether the to-be-processed command has been processed may be judged. In addition, the stored historical command may be updated based on the to-be-processed command, to maintain the timeliness of the historical command.

Step S102: under a condition that the comparison result is that there is a historical command the same as the to-be-processed command in the at least one historical command, generating a first calculation result based on a first preset algorithm and a stored historical calculation result corresponding to the to-be-processed command, updating the stored historical calculation result based on the first calculation result, and feeding back the first calculation result to a target terminal device.

If the comparison result is that there is the historical command the same as the to-be-processed command in the at least one historical command, it may be regarded that the to-be-processed command has been processed, and a corresponding historical calculation result is obtained. To output different calculation results for the same command, the first calculation result may be generated based on the first preset algorithm and the historical calculation result corresponding to the to-be-processed command, and the first calculation result may be regarded as being obtained by performing iterative processing on the to-be-processed command. In addition, the first calculation result is used for updating the historical calculation result, which may be used as input data of a next iterative calculation. The first preset algorithm may be AES (Advanced Encryption Standard), RSA, and other algorithms, which is not limited in this disclosure.

Step S103: under a condition that the comparison result is that the historical command is different from the to-be-processed command, generating a second calculation result based on a second preset algorithm and the to-be-processed command, updating the stored historical calculation result based on the second calculation result, and feeding back the second calculation result to the target terminal device.

If the comparison result is that the historical command is different from the to-be-processed command, it may be regarded that the to-be-processed command has not been processed, and the second calculation result may be directly generated based on the second preset algorithm and the to-be-processed command. The second preset algorithm may be an AES (Advanced Encryption Standard), an RSA algorithm, and the like, which is not limited in this disclosure. It should be noted that if the host sends a command A for the first time, the slave may process the command A based on the second preset algorithm to obtain a calculation result B and feed back the calculation result B to the host. At this time, the host may perform authentication based on the calculation result B and generate a reference result C based on the first preset algorithm and the calculation result B. If the host sends the command A for the second time, when judging that the same command A is received, the slave may process the stored calculation result B based on the first preset algorithm to obtain a calculation result C, store the calculation result C, and feed back the calculation result C to the host. At this time, the host may judge that the reference result C is consistent with the calculation result C, thereby completing the authentication. If the host sends the command A for the third time, when judging that the same command A is received, the slave may continue to process the stored calculation result C based on the first preset algorithm, and so on.

As described above, by feeding back different processing results generated based on the to-be-processed command itself or the historical calculation result for the same communication command, so that the flexibility of authentication calculation may be improved, thereby increasing the imitation difficulty of the chip, improving the security of the authentication process, and reducing the security risk.

The communication command processing method in this embodiment of this disclosure is applied to a communication command processing circuit. The whole solution has been described in detail in related embodiments of the communication command processing circuit. For any descriptions not described in detail in the communication command processing method, reference may be made to an embodiment of the communication command processing circuit, and the communication command processing method achieves the same technical effects.

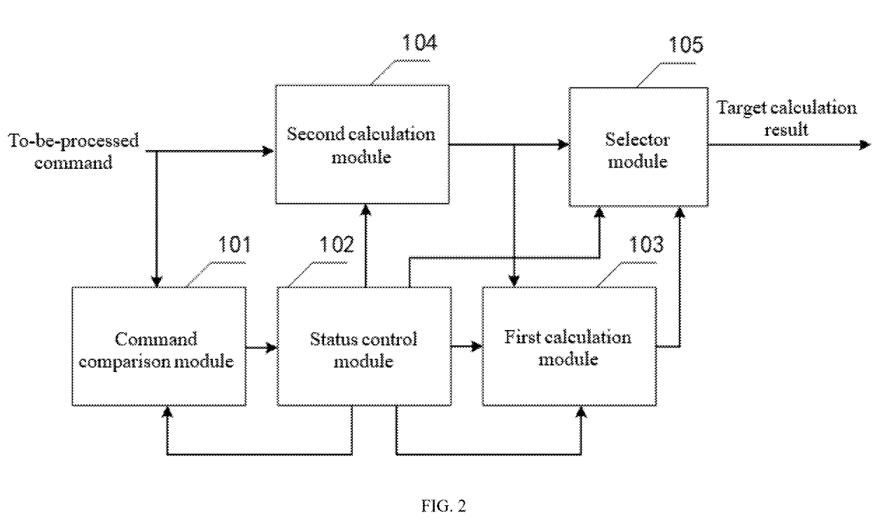

FIG. 2 is a schematic structural diagram of a communication command processing circuit according to an embodiment of this disclosure. The communication command processing circuit may be used for implementing the communication command processing method provided by the foregoing embodiment. As shown in FIG. 2, the communication command processing circuit includes a command comparison module 101, a status control module 102, a first calculation module 103, a second calculation module 104, and a selector module 105.

A first end of the command comparison module 101 is configured to receive a to-be-processed command. A second end of the command comparison module 101 is connected to a first end of the status control module 102 and configured to output a comparison result obtained by comparing the to-be-processed command with at least one stored historical command to the status control module 102.

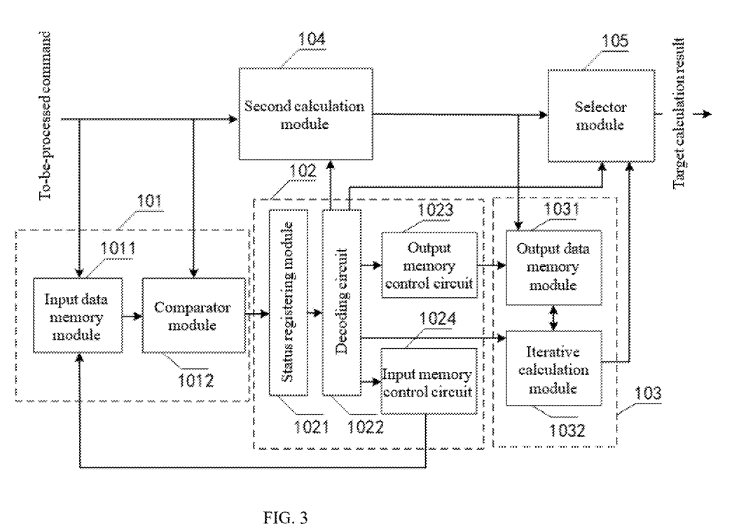

In an embodiment, FIG. 3 is a schematic structural diagram of another communication command processing circuit according to an embodiment of this disclosure. Based on FIG. 2, as shown in FIG. 3, the command comparison module 101 includes an input data memory module 1011 and a comparator module 1012. The input data memory module 1011 may be configured to store the at least one historical command. A first end of the input data memory module 1011 and a first end of the comparator module 1012 may be used as the first end of the command comparison module 101 and configured to receive the to-be-processed command. A second end of the input data memory module 1011 is connected to a second end of the comparator module 1012 and configured to provide the at least one historical command for the comparator module 1012. A third end of the comparator module 1012 is used as the second end of the command comparison module 101 and configured to output the comparison result obtained by comparing the to-be-processed command with the at least one historical command to the status control module 102. A third end of the input data memory module 1011 is used as a third end of the command comparison module 101.

A second end of the status control module 102 is connected to a first end of the first calculation module 103 and configured to output a first control signal to the first calculation module 103 under a condition that the comparison result is that there is a historical command the same as the to-be-processed command in the at least one historical command. A third end of the status control module 102 is connected to a first end of the second calculation module 104 and configured to output a second control signal to the second calculation module 104 under a condition that the comparison result is that the historical command is different from the to-be-processed command. A fourth end of the status control module 102 is connected to the third end of the command comparison module 101 and configured to control the command comparison module 101 to update the at least one stored historical command based on the to-be-processed command. A fifth end of the status control module 102 is connected to a first end of the selector module 105 and configured to output a result selection signal to the selector module 105 according to the comparison result.

In an embodiment, as shown in FIG. 3 , the status control module 102 includes a status registering module 1021, a decoding circuit 1022, an output memory control circuit 1023, and an input memory control circuit 1024. A first end of the status registering module 1021 is used as the first end of the status control module 102 and configured to receive the comparison result that is obtained by comparing the to-be-processed command with the at least one stored historical command and that is output by the command comparison module 101. A second end of the status registering module 1021 is connected to a first end of the decoding circuit 1022 and configured to output a status code corresponding to the comparison result to the decoding circuit 1022. A second end of the decoding circuit 1022 is used as the second end of the status control module 102 and configured to output the first control signal to the first calculation module 103 under a condition that the status code indicates that there is the historical command the same as the to-be-processed command in the at least one historical command. A third end of the decoding circuit 1022 is used as the third end of the status control module 102 and configured to output the second control signal to the second calculation module 104 under a condition that the status code indicates that the historical command is different from the to-be-processed command. A fourth end of the decoding circuit 1022 is used as the fifth end of the status control module 102 and configured to output the result selection signal to the selector module 105 according to the status code. A fifth end of the decoding circuit 1022 is connected to a first end of the input memory control circuit 1024 and configured to output a first updating signal to the input memory control circuit 1024. A second end of the input memory control circuit 1024 is used as the fourth end of the status control module 102 and configured to control, according to the first updating signal, the command comparison module 101 to update the at least one stored historical command based on the to-be-processed command. A sixth end of the decoding circuit 1022 is connected to a first end of the output memory control circuit 1023 and configured to output a second updating signal to the output memory control circuit 1023. A second end of the output memory control circuit 1023 is used as a sixth end of the status control module 102 and configured to control, according to the second updating signal, the first calculation module 103 to update a stored historical calculation result based on a first calculation result or a second calculation result.

A second end of the first calculation module 103 is connected to a second end of the selector module 105 and configured to output the first calculation result generated based on a first preset algorithm and a stored historical calculation result corresponding to the to-be-processed command to the selector module 105 under a condition that the first control signal is received.

Optionally, if some authentication commands require short feedback time in an authentication process, the communication command processing circuit needs to feed back the calculation results in time, and the first calculation module 103 may be correspondingly configured to: output the stored historical calculation result corresponding to the to-be-processed command to the selector module 105 under a condition that the first control signal is received, to achieve the purpose of quickly feeding back result data, adapting to scenarios with high requirements for authentication efficiency.

In an embodiment, as shown in FIG. 3, the first calculation module 103 includes an output data memory module 1031 and an iterative calculation module 1032. A first end of the iterative calculation module 1032 is used as the first end of the first calculation module 103 and configured to receive the first control signal output by the status control module 102. A second end of the iterative calculation module 1032 is used as the second end of the first calculation module 103 and configured to output the first calculation result generated based on the first preset algorithm and the historical calculation result corresponding to the to-be-processed command to the selector module 105 under a condition that the first control signal is received. The output data memory module 1031 is configured to store at least one historical calculation result. A first end of the output data memory module 1031 is connected to a third end of the iterative calculation module 1032 and configured to provide the historical calculation result corresponding to the to-be-processed command for the iterative calculation module 1032 or receive the first calculation result generated by the iterative calculation module 1032. A second end of the output data memory module 1031 is used as a third end of the first calculation module 103 and configured to receive the second calculation result output by the second calculation module 104. A third end of the output data memory module 1031 is used as a fourth end of the first calculation module 103.

A second end of the second calculation module 104 is configured to receive the to-be-processed command. A third end of the second calculation module 104 is connected to a third end of the selector module 105 and the third end of the first calculation module 103, and configured to output the second calculation result generated based on a second preset algorithm and the to-be-processed command to the selector module 105 and the first calculation module 103 under a condition that the second control signal is received.

The sixth end of the status control module 102 is connected to the fourth end of the first calculation module 103 and configured to control the first calculation module 103 to update the stored historical calculation result based on the first calculation result or the second calculation result.

A fourth end of the selector module 105 is configured to output a target calculation result determined from the first calculation result and the second calculation result according to the result selection signal to a target terminal device.

As described above, by disposing different calculation modules and selecting a specific calculation module according to the command comparison result, different processing results generated based on the to-be-processed command itself or the historical calculation result may be fed back for the same communication command, so that the flexibility of authentication calculation is improved, thereby increasing the imitation difficulty of the chip, improving the security of the authentication process, and reducing the security risk.

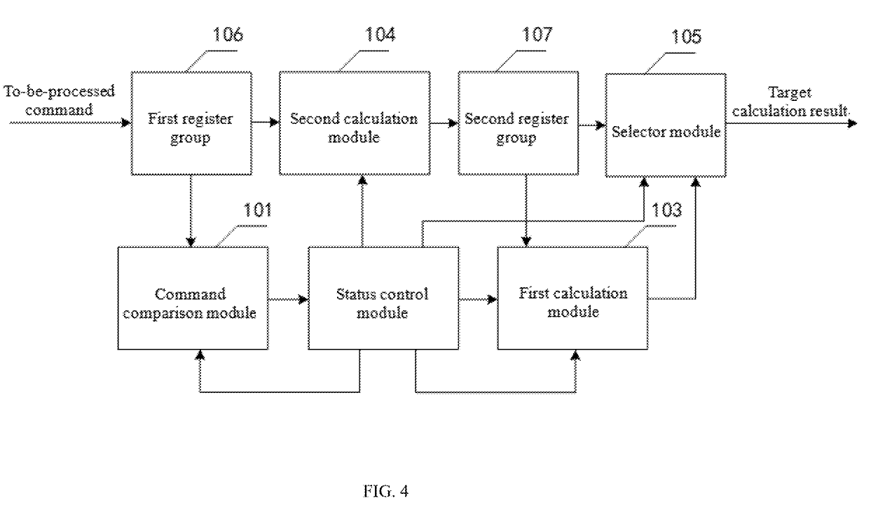

In an embodiment, FIG. 4 is a schematic structural diagram of another communication command processing circuit according to an embodiment of this disclosure, and based on FIG. 2, as shown in FIG. 4, the communication command processing circuit further includes a first register group 106. A first end of the first register group 106 is configured to receive and store the to-be-processed command. A second end of the first register group 106 is connected to the first end of the command comparison module 101 and configured to output the to-be-processed command to the command comparison module 101. A third end of the first register group 106 is connected to a second end of the second calculation module 104 and configured to output the to-be-processed command to the second calculation module 104.

In an embodiment, as shown in FIG. 4, the communication command processing circuit further includes a second register group 107. A first end of the second register group 107 is connected to a third end of the second calculation module 104 and configured to receive and store a second calculation result. A second end of the second register group 107 is connected to a third end of the selector module 105 and configured to output the second calculation result to the selector module 105. A third end of the second register group 107 is connected to a third end of the first calculation module 103 and configured to output the second calculation result to the first calculation module 103.

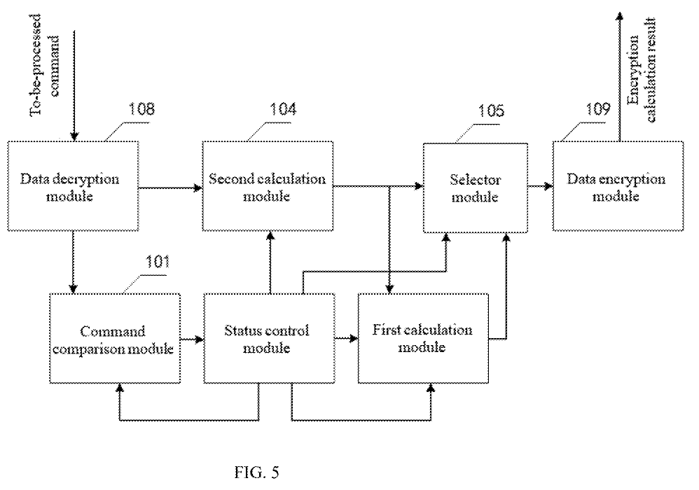

In an embodiment, FIG. 5 is a schematic structural diagram of another communication command processing circuit according to an embodiment of this disclosure, and as shown in FIG. 5, the communication command processing circuit further includes a data decryption module 108. A first end of the data decryption module 108 is configured to receive a to-be-processed command. A second end of the data decryption module 108 is connected to a first end of a command comparison module 101 and configured to output a decryption calculation result obtained by decrypting the to-be-processed command based on a preset decryption algorithm to the command comparison module 101. A third end of the data decryption module 108 is connected to a second end of a second calculation module 104 and configured to output the decryption calculation result obtained by decrypting the to-be-processed command based on the preset decryption algorithm to the second calculation module 104.

In an embodiment, as shown in FIG. 5, the communication command processing circuit further includes a data encryption module 109. A first end of the data encryption module 109 is connected to a fourth end of a selector module 105 and configured to receive a target calculation result. A second end of the data encryption module 109 is configured to output an encryption calculation result obtained by encrypting the target calculation result based on a preset encryption algorithm to a target terminal device.

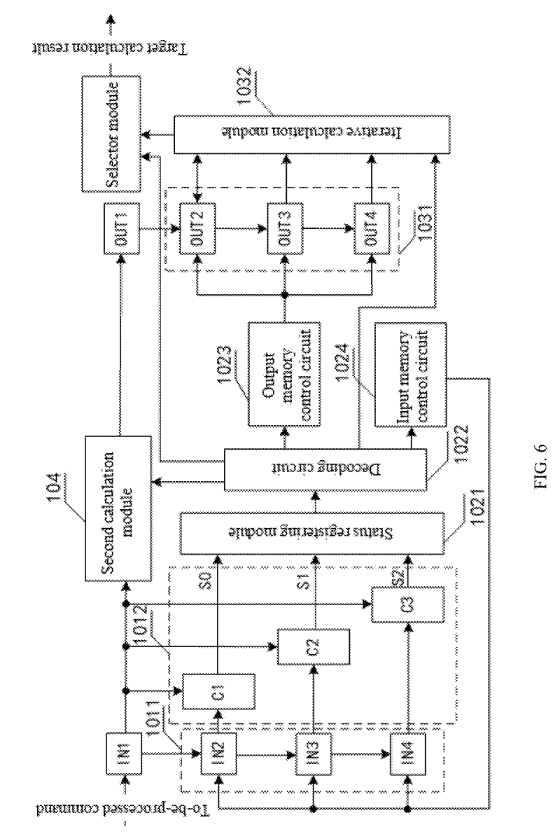

In an embodiment, FIG. 6 is a schematic structural diagram of another communication command processing circuit according to an embodiment of this disclosure, and based on FIG. 3, as shown in FIG. 6, a register group IN1 is disposed for storing the to-be-processed command. The input data memory module 1011 includes a register group IN2, a register group IN3, and a register group IN4. The comparator module 1012 includes a comparator C1, a comparator C2, and a comparator C3 that are disposed corresponding to the register group IN2, the register group IN3, and the register group IN4 respectively. Specifically, a register group OUT1 is further disposed for storing a calculation result output by the second calculation module 104. The output data memory module 1031 includes a register group OUT2, a register group OUT3, and a register group OUT4.

The register group IN2 is configured to store a most recent historical command, the register group IN3 is configured to store a relatively recent historical command, and the register group IN4 is configured to store an oldest historical command. The register group OUT2 is configured to store a historical calculation result corresponding to the historical command stored in the register group IN2, the register group OUT3 is configured to store a historical calculation result corresponding to the historical command stored in the register group IN3, and the register group OUT4 is configured to store a historical calculation result corresponding to the historical command stored in the register group IN4.

In a specific implementation process, the comparator C1 may output a result S0 by comparing the historical command provided by the register group IN2 and the to-be-processed command provided by the register group IN1. When the historical command and the to-be-processed command are the same, S0 is logic 1, and when the historical command and the to-be-processed command are different, S0 is logic 0. The comparator C2 may output a result S1 by comparing the historical command provided by the register group IN3 and the to-be-processed command provided by the register group IN1. When the historical command and the to-be-processed command are the same, S1 is logic 1, and when the historical command and the to-be-processed command are different, S1 is logic 0. The comparator C3 may output a result S2 by comparing the historical command provided by the register group IN4 and the to-be-processed command provided by the register group IN1. When the historical command and the to-be-processed command are the same, S2 is logic 1, and when the historical command and the to-be-processed command are different, S2 is logic 0. The status registering module 1021 is configured to save values of S0, S1, and S2 and generate the status code. The results may be 000, 100, 010, and 001. If the result is 000, it indicates that the to-be-processed command is different from the stored historical commands. If the result is 100, it indicates that the to-be-processed command is the same as the historical command stored in the register group IN2. If the result is 010, it indicates that the to-be-processed command is the same as the historical command stored in the register group IN3. If the result is 001, it indicates that the to-be-processed command is the same as the historical command stored in the register group IN4. The decoding circuit 1022 outputs the first control signal to the second calculation module 104 under a condition that the status code is 000, so that the second calculation module 104 may generate the second calculation result based on the second preset algorithm and the to-be-processed command. The decoding circuit 1022 outputs the second control signal to the iterative calculation module 1032 under a condition that the status code is 100, 010, or 001, so that the iterative calculation module 1032 may generate the first calculation result based on the first preset algorithm and the stored historical calculation result corresponding to the to-be-processed command.

Specifically, the input memory control circuit 1024 may be configured to control data updating of the register group IN2, the register group IN3, and the register group IN4. The register group IN2 is configured to store the most recent historical command. For example, if the to-be-processed command is A1, and the historical commands respectively stored in the register group IN2, the register group IN3, and the register group IN4 are B1, C1, and D1, a corresponding status code is 000. Since the to-be-processed command is different from the historical commands, the input memory control circuit 1024 may correspondingly update the historical commands stored in the register group IN2, the register group IN3, and the register group IN4 respectively to A1, B1, and C1. For another example, if the to-be-processed command is B1, and the historical commands respectively stored in the register group IN2, the register group IN3, and the register group IN4 are A1, B1, and C1, a corresponding status code is 010. Since the to-be-processed command B1 is the same as the historical command B1 stored in the register group IN3, the historical command C1 stored in the register group IN4 may be kept unchanged, while B1 stored in the register group IN3 may be replaced with A1, and A1 stored in the register group IN2 may be replaced with B1, that is, the historical commands respectively stored in the register group IN2, the register group IN3, and the register group IN4 are B1, A1, and C1.

Specifically, the output memory control circuit 1023 may be configured to control data updating of the register group OUT2, the register group OUT3, and the register group OUT4. After data updating occurs on the register group IN2, the register group IN3, and the register group IN4, the output memory control circuit 1023 may control the historical calculation result stored in the register group OUT2 to match the historical command stored in the register group IN2, the historical calculation result stored in the register group OUT3 to match the historical command stored in the register group IN3, and the historical calculation result stored in the register group OUT4 to match the historical command stored in the register group IN4.

Further, if the same command is received for multiple times, a calculation result corresponding to the command is continuously iterated based on the historical calculation result. For example, if the historical commands respectively stored in the register group IN2, the register group IN3, and the register group IN4 are A1, B1, and C1, and the historical calculation results respectively stored in the register group OUT2, the register group OUT3, and the register group OUT4 are A2, B2, and C2, a corresponding status code is 010 when the to-be-processed command is B1, and the iterative calculation module 1032 may perform calculation based on the historical calculation result B2 stored in the register group OUT3 to obtain B3. Correspondingly, the output memory control circuit 1023 may update the historical calculation result stored in the register group OUT2 to B3. In addition, the output memory control circuit 1023 may update the historical commands respectively stored in the register group IN2, the register group IN3, and the register group IN4 to B1, A1, and C1. Correspondingly, the output memory control circuit 1023 may update the historical calculation results respectively stored in the register group OUT2, the register group OUT3, and the register group OUT4 to B3, A2, and C2. By analogy, if the register group IN1 receives the to-be-processed command B1 again, after completing an iterative calculation to obtain B4, the historical commands respectively stored in the register group IN2, the register group IN3, and the register group IN4 are B1, A1, and C1. In addition, the historical calculation results respectively stored in the register group OUT2, the register group OUT3, and the register group OUT4 are B4, A2, and C2.

Certainly, the foregoing descriptions are examples only. The specific number of the register groups and comparators may be adaptively set according to the storage requirements of actual application scenarios, which is not limited in this disclosure.

An embodiment of this disclosure further provides a chip, including the communication command processing circuit provided in the foregoing embodiment, and having corresponding functions and beneficial effects with the communication command processing circuit.

An embodiment of this disclosure further provides an electronic device, including the chip provided in the foregoing embodiment.

It should be noted that the sequence numbers of the steps in this solution are only used for describing the overall design framework of this solution, and do not represent the necessarily sequential relationships between the steps. On the basis of conforming to the overall design framework of this solution, the overall implementation process falls within the protection scope of this disclosure, and the sequential order in the form of text is not an exclusive limitation on the specific implementation process of this disclosure.

It should be further noted that the terms “comprise”, “include” or any other variations thereof are intended to cover non-exclusive inclusion, so that the procedure, method, commodity, or device including a series of elements not only includes those elements, but also includes other elements that are not specifically listed, or also includes inherent elements of this procedure, method, commodity, or device. An element preceded by “includes a...” does not, without more constraints, preclude the existence of additional identical elements in the process, method, commodity, or device that includes the element.

It should be noted that the above descriptions are only the preferred embodiments of this disclosure and the applied technical principles. Those skilled in the art may understand that this disclosure is not limited to the specific embodiments described herein, and that various obvious changes, readjustments, and replacements can be made by those skilled in the art without departing from the protection scope of this disclosure. Therefore, although this disclosure has been described in detail through the above embodiments, this disclosure is not limited to the above embodiments only. Without departing from the concept of this disclosure, more other equivalent embodiments may be included, and the scope of this disclosure is determined by the scope of the appended claims.

What is claimed is:

1. A communication command processing method, wherein the method comprises:
acquiring a to-be-processed command, comparing the to-be-processed command with at least one stored historical command to obtain a comparison result, and updating the at least one stored historical command based on the to-be-processed command;
under a condition that the comparison result is that there is a historical command the same as the to-be-processed command in the at least one historical command, generating a first calculation result based on a first preset algorithm and a stored historical calculation result corresponding to the to-be-processed command, updating the stored historical calculation result based on the first calculation result, and feeding back the first calculation result to a target terminal device; and
under a condition that the comparison result is that the historical command is different from the to-be-processed command, generating a second calculation result based on a second preset algorithm and the to-be-processed command, updating the stored historical calculation result based on the second calculation result, and feeding back the second calculation result to the target terminal device.

2. A communication command processing circuit, comprising:
a command comparison module, configured to receive a to-be-processed command, and configured to output a comparison result obtained by comparing the to-be-processed command with at least one stored historical command to a status control module;
the status control module, configured to output a first control signal to a first calculation module under a condition that the comparison result is that there is a historical command the same as the to-be-processed command in the at least one historical command, configured to output a second control signal to a second calculation module under a condition that the comparison result is that the historical command is different from the to-be-processed command, configured to control the command comparison module to update the at least one stored historical command based on the to-be-processed command, and configured to output a result selection signal to a selector module according to the comparison result;
the first calculation module, configured to output a first calculation result generated based on a first preset algorithm and a stored historical calculation result corresponding to the to-be-processed command to the selector module under a condition that the first control signal is received;
the second calculation module, configured to receive the to-be-processed command, and configured to output a second calculation result generated based on a second preset algorithm and the to-be-processed command to the selector module and the first calculation module under a condition that the second control signal is received;
the status control module, further configured to control the first calculation module to update the stored historical calculation result based on the first calculation result or the second calculation result; and
the selector module, configured to output a target calculation result determined from the first calculation result and the second calculation result according to the result selection signal to a target terminal device.

3. The communication command processing circuit according to claim 2, wherein the status control module comprises a status registering module, a decoding circuit, an output memory control circuit, and an input memory control circuit;
the status registering module is configured to output a status code corresponding to the comparison result to the decoding circuit;
the decoding circuit is configured to output the first control signal to the first calculation module under a condition that the status code indicates that there is the historical command the same as the to-be-processed command in the at least one historical command, configured to output a first updating signal to the input memory control circuit, configured to output the second control signal to the second calculation module under a condition that the status code indicates that the historical command is different from the to-be-processed command, configured to output a second updating signal to the output memory control circuit, and configured to output the result selection signal to the selector module according to the status code;
the input memory control circuit is configured to control, according to the first updating signal, the command comparison module to update the at least one stored historical command based on the to-be-processed command; and
the output memory control circuit is configured to control, according to the second updating signal, the first calculation module to update the stored historical calculation result based on the first calculation result or the second calculation result.

4. The communication command processing circuit according to claim 2, wherein the command comparison module comprises an input data memory module and a comparator module;
the input data memory module is configured to receive the to-be-processed command, configured to store the at least one historical command, and configured to provide the at least one historical command for the comparator module; and
the comparator module is configured to output the comparison result obtained by comparing the to-be-processed command with the at least one historical command to the status control module.

5. The communication command processing circuit according to claim 2, wherein the first calculation module comprises an output data memory module and an iterative calculation module;
the output data memory module is configured to receive the second calculation result output by the second calculation module, configured to store at least one historical calculation result, and configured to provide the historical calculation result corresponding to the to-be-processed command for the iterative calculation module; and
the iterative calculation module is configured to output the first calculation result generated based on the first preset algorithm and the historical calculation result corresponding to the to-be-processed command to the selector module under a condition that the first control signal is received.

6. The communication command processing circuit according to claim 2, wherein the communication command processing circuit further comprises a first register group; and
the first register group is configured to receive and store the to-be-processed command, and configured to output the to-be-processed command to the command comparison module and the second calculation module.

7. The communication command processing circuit according to claim 2, wherein the communication command processing circuit further comprises a second register group; and
the second register group is configured to receive and store the second calculation result and output the second calculation result to the first calculation module and the selector module.

8. The communication command processing circuit according to claim 2, wherein the communication command processing circuit further comprises a data decryption module; and
the data decryption module is configured to receive the to-be-processed command, and configured to output a decryption calculation result obtained by decrypting the to-be-processed command based on a preset decryption algorithm to the command comparison module and the second calculation module.

9. The communication command processing circuit according to claim 2, wherein the communication command processing circuit further comprises a data encryption module; and
the data encryption module is configured to receive the target calculation result, and configured to output an encryption calculation result obtained by encrypting the target calculation result based on a preset encryption algorithm to the target terminal device.

10. A chip, comprising the communication command processing circuit according to claim 2.

11. An electronic device, comprising the chip according to claim 10.
